(19) United States
(12) Patent Application Publication
(10) Pub. No.: US 2016/0182356 A1
(43) Pub. Date: Jun. 23, 2016

(54) CONDITIONAL AND UNCONDITIONAL RULE TABLE ACTIONS

(71) Applicant: Alcatel-Lucent Canada Inc., Ottawa (CA)

(72) Inventor: Robert A. Mann, Carp (CA)

(73) Assignee: Alcatel-Lucent Canada Inc.

(21) Appl. No.: 14/576,075

(22) Filed: Dec. 18, 2014

(51) Int. Cl. H04L 12/721; H04L 12/24

(52) U.S. Cl. CPC H04L 45/14; H04L 41/046

(57) ABSTRACT

Various exemplary embodiments relate to a method on a non-transitory medium which may be performed by a Diameter device for managing a Diameter rules table. The method may include, retrieving a first Diameter rule from the Diameter rules table; determining a set of criteria associated with the first Diameter rule; when the set of criteria is non-empty, executing an action associated with the first Diameter rule and ending evaluation of a rules set; and when the set of criteria is empty, executing an action associated with the first Diameter rule and retrieving a second Diameter rule from the Diameter rules table for evaluation.

### TECHNICAL FIELD

Various exemplary embodiments disclosed herein relate generally to computer networking, and more particularly but not exclusively, to Diameter protocol devices.

### BACKGROUND

Since its proposal in Internet Engineering Task Force (IETF) Request for Comments (RFC) 3588, the Diameter protocol has been increasingly adopted by numerous networked applications. For example, the Third Generation Partnership Project (3GPP) has adopted Diameter for various policy and charging control (PCC), mobility management, and IP multimedia subsystem (IMS) applications. As IP-based networks replace circuit-switched networks, Diameter is even replacing SS7 as the key communications signaling protocol. As networks evolve, Diameter is becoming a widely used protocol among wireless and wireline communications networks.

One significant aspect of the Diameter protocol is Diameter packet routing. Entities referred to as Diameter routing agents (DRAs) facilitate movement of packets in a network. In various deployments, DRAs may perform elementary functions such as simple routing, proxying, and redirect.

### SUMMARY

A brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a method performed by a Diameter device for managing a Diameter rules table, the method including, retrieving a first Diameter rule from the Diameter rules table; determining a set of criteria associated with the first Diameter rule; when the set of criteria is non-empty and is met, executing an action associated with the first Diameter rule and ending evaluation of a rules set; and when the set of criteria is empty, executing an action associated with the first Diameter rule and retrieving a second Diameter rule from the Diameter rules table for evaluation.

Various exemplary embodiments are described including retrieving a second diameter rule from the Diameter rules table when the set of criteria is non-empty and the set of criteria is not met.

Various exemplary embodiments are described wherein the Diameter rules table contains multiple sets of empty criteria.

Various exemplary embodiments are described wherein the Diameter device retrieves a different Diameter rule subsequent to evaluation of each empty criteria.

Various exemplary embodiments are described wherein determining a set of criteria further comprises: one criterion in the set which is empty; and wherein the Diameter device continues evaluation of the rule set when the criterion is determined to be empty.

Various exemplary embodiments are described including executing multiple actions associated with the first Diameter rule when the set of criteria is non-empty.

Various exemplary embodiments are described including a non-transitory machine-readable storage medium encoded with instructions for execution by a Diameter Routing Agent for managing a Diameter queue, the medium including instructions for receiving a first Diameter rule to be placed in the Diameter rules table; instructions for evaluating the first Diameter rule to determine a set of criteria associated with the first Diameter rule; instructions for when the set of criteria are conditional and is met, executing all actions associated with the first Diameter rule; and instructions for determining an action to take based upon the applied throttling rules. when the set of criteria are unconditional, receiving a second Diameter rule from the Diameter rules table.

Various exemplary embodiments are described including instructions for retrieving a second diameter rule from the Diameter rules table when the set of criteria is non-empty and the set of criteria is not met.

Various exemplary embodiments are described wherein the Diameter rules table contains multiple sets of empty criteria.

Various exemplary embodiments are described wherein the Diameter device retrieves a different Diameter rule subsequent to evaluation of each empty criteria.

Various exemplary embodiments are described wherein determining a set of criteria further comprises: one criterion in the set which is empty; and wherein the Diameter device continues evaluation of the rule set when the criterion is determined to be empty.

Various exemplary embodiments are described further comprising: executing multiple actions associated with the first Diameter rule when the set of criteria is non-empty.

Various exemplary embodiments are described including a Diameter Routing agent (DRA) for managing a Diameter rules queue, the DRA including a rule storage configured to store a Diameter rules table; a processor configured to: receive a first Diameter rule to be placed in the Diameter rules table; evaluate the first Diameter rule to determine a set of criteria associated with the first Diameter rule; when the set of criteria are conditional and satisfied, execute all actions associated with the first Diameter rule; and when the set of criteria are unconditional, receive a second Diameter rule from the Diameter rules table.

Various exemplary embodiments are described wherein the DRA is further configured to: retrieve a second diameter rule from the Diameter rules table when the set of criteria is non-empty and the set of criteria is not met.

Various exemplary embodiments are described wherein the DRA is further configured to: retrieve a different Diameter rule subsequent to evaluation of each empty criteria.

Various exemplary embodiments are described wherein to determine a set of criteria, the DRA is further configured to: determine one criterion in the set which is empty; and the DRA continues to evaluate the rule set when the criterion is determined to be empty.

Various exemplary embodiments are described wherein the DRA is further configured to: execute multiple actions associated with the first Diameter rule when the set of criteria is non-empty.

Various exemplary embodiments are described wherein to receive a first Diameter rule the DRA is further configured to: receive a list of rules from a user using a user interface, the list including conditional and unconditional rules.

Various exemplary embodiments are described including a method performed by a Diameter device for managing Diameter rules, the method comprising: traversing a Diameter rules table, wherein traversing includes: the ability to execute an action that has criteria when that criteria is satisfied; and the ability to execute an unconditional action regardless of whether an action associated with a rule having criteria was executed.

Various exemplary embodiments are described retrieving a first Diameter rule from the Diameter rules table; executing an unconditional action of the first Diameter rule; determining a set of criteria associated with the first Diameter rule; and when the criteria includes a condition, executing an action associated with the first Diameter rule and ending evaluation of a rules set.

Various exemplary embodiments are described retrieving a second diameter rule from the Diameter rules table when the set of criteria is not met.

Various exemplary embodiments are described wherein the Diameter rules table contains multiple sets of unconditional actions and executes an action for each.

Various exemplary embodiments are described including populating the first Diameter rules table with conditional actions; and populating a second Diameter rules table with unconditional actions.

Various exemplary embodiments are described executing actions in the second Diameter rules table; and executing an action in the first rules table with a satisfied condition.

Various exemplary embodiments are described including a non-transitory machine-readable storage medium encoded with instructions for execution by a Diameter device for managing Diameter rules, the medium comprising: instructions for traversing a Diameter rules table, wherein traversing includes: the ability to execute an action that has criteria when that criteria is satisfied; and the ability to execute an unconditional action regardless of whether an action associated with a rule having criteria was executed.

Various exemplary embodiments are described including retrieving a first Diameter rule from the Diameter rules table; executing an unconditional action of the first Diameter rule; determining a set of criteria associated with the first Diameter rule; and when the criteria includes a condition, executing an action associated with the first Diameter rule and ending evaluation of a rules set.

Various exemplary embodiments are described retrieving a second diameter rule from the Diameter rules table when the set of criteria is not met.

Various exemplary embodiments are described wherein the Diameter rules table contains multiple sets of unconditional actions and executes an action for each.

Various exemplary embodiments are described populating the first Diameter rules table with conditional actions; and populating a second Diameter rules table with unconditional actions.

Various exemplary embodiments are described executing actions in the second Diameter rules table; and executing an action in the first rules table with a satisfied condition.

Various exemplary embodiments are described including a Diameter Routing agent (DRA) for managing Diameter rules, the DRA comprising: a rule storage configured to store a Diameter rules table; a processor configured to: traverse the Diameter rules table, wherein traversing includes: the ability to execute an action that has criteria when that criteria is satisfied; and the ability to execute an unconditional action regardless of whether an action associated with a rule having criteria was executed.

Various exemplary embodiments are described wherein the processor is further configured to: retrieve a first Diameter rule from the Diameter rules table; execute an unconditional action of the first Diameter rule; determine a set of criteria associated with the first Diameter rule; and when the criteria includes a condition, execute an action associated with the first Diameter rule and end evaluation of a rules set.

Various exemplary embodiments are described wherein the processor is further configured to: retrieve a second diameter rule from the Diameter rules table when the set of criteria is not met.

Various exemplary embodiments are described wherein the Diameter rules table contains multiple sets of unconditional actions and executes an action for each.

Various exemplary embodiments are described wherein the processor is further configured to: populate the first Diameter rules table with conditional actions; and populate a second Diameter rules table with unconditional actions.

Various exemplary embodiments are described wherein the processor is further configured to: execute actions in the second Diameter rules table; and execute an action in the first rules table with a satisfied condition.

### BRIEF DESCRIPTION OF THE DRAWINGS

In order to better understand various exemplary embodiments, reference is made to the accompanying drawings, wherein:

FIG. 1 illustrates an exemplary network environment for a Diameter routing agent;

FIG. 2 illustrates an exemplary Diameter system;

FIG. 3 illustrates an exemplary Diameter rules engine system;

FIG. 4 illustrates an exemplary first method for managing Diameter rules;

FIG. 5 illustrates an exemplary second method for managing Diameter rules;

FIG. 6 illustrates an exemplary third method for managing Diameter rules;

FIG. 7 illustrates an exemplary hardware diagram for a device; and

FIG. 8 illustrates an exemplary unconditional rule.

To facilitate understanding, identical reference numerals have been used to designate elements having substantially the same or similar structure or substantially the same or similar function.

### DETAILED DESCRIPTION

The description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various embodiments described herein are not necessarily mutually exclusive, as some embodiments can be combined with one or more other embodiments to form new embodiments.

Rules engines, used in Diameter network systems and routers can be bogged down from excessive rules creation and execution based on complex decision trees. It would be beneficial to assess Diameter rules using less overhead.

Referring now to the drawings, in which like numerals refer to like components or steps, there are disclosed broad aspects of various exemplary embodiments.

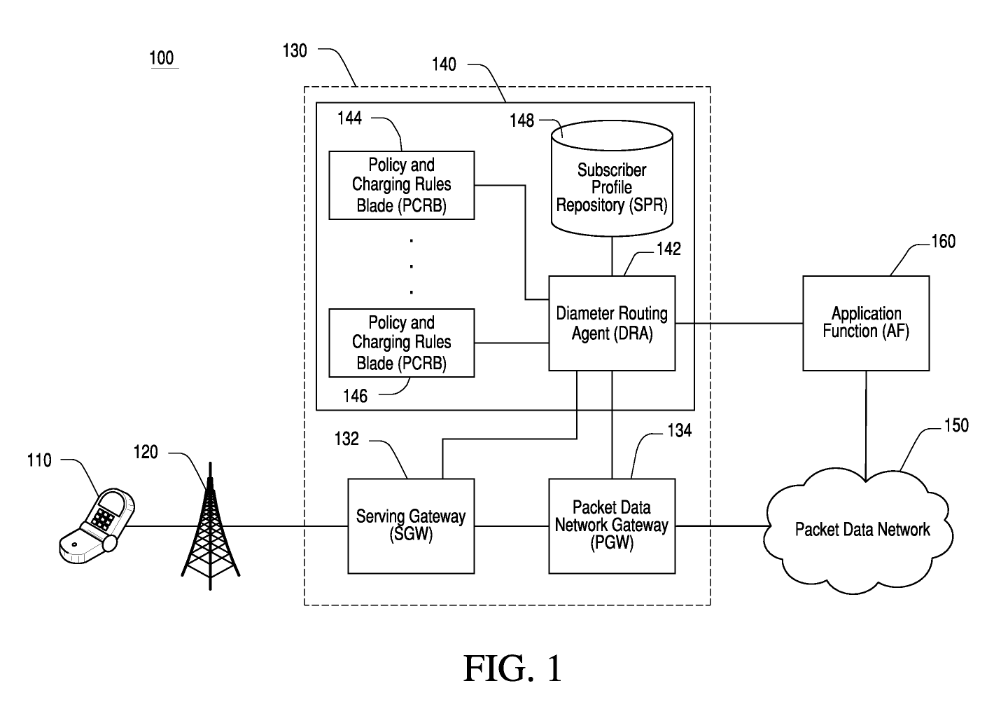

FIG. 1 illustrates an exemplary network environment 100 for a Diameter Routing Agent (DRA) 142. Exemplary network environment 100 may be a subscriber network for providing various services. In various embodiments, subscriber network 100 may be a public land mobile network (PLMN). Exemplary subscriber network 100 may be telecommunications network or other network for providing access to various services. Exemplary subscriber network 100 may include user equipment 110, base station 120, evolved packet core (EPC) 130, packet data network 150, and application function (AF) 160.

User equipment 110 may be a device that communicates with packet data network 150 for providing the end-user with a data service. Such data service may include, for example, voice communication, text messaging, multimedia streaming, and Internet access. More specifically, in various exemplary embodiments, user equipment 110 is a personal or laptop computer, wireless email device, cell phone, tablet, television set-top box, or any other device capable of communicating with other devices via EPC 130.

Base station 120 may be a device that enables communication between user equipment 110 and EPC 130. For example, base station 120 may be a base transceiver station such as an evolved nodeB (eNodeB) as defined by the relevant 3GPP standards. Thus, base station 120 may be a device that communicates with user equipment 110 via a first medium, such as radio waves, and communicates with EPC 130 via a second medium, such as Ethernet cable. Base station 120 may be in direct communication with EPC 130 or may communicate via a number of intermediate nodes (not shown). In various embodiments, multiple base stations (not shown) may be present to provide mobility to user equipment 110. Note that in various alternative embodiments, user equipment 110 may communicate directly with EPC 130. In such embodiments, base station 120 may not be present.

Evolved packet core (EPC) 130 may be a device or network of devices that provides user equipment 110 with gateway access to packet data network 140. EPC 130 may further charge a subscriber for use of provided data services and ensure that particular quality of experience (QoE) standards are met. Thus, EPC 130 may be implemented, at least in part, according to the relevant 3GPP standards. EPC 130 may include a serving gateway (SGW) 132, a packet data network gateway (PGW) 134, and a session control device 140.

Serving gateway (SGW) 132 may be a device that provides gateway access to the EPC 130. SGW 132 may be one of the first devices within the EPC 130 that receives packets sent by user equipment 110. Various embodiments may also include a mobility management entity (MME) (not shown) that receives packets prior to SGW 132. SGW 132 may forward such packets toward PGW 134. SGW 132 may perform a number of functions such as, for example, managing mobility of user equipment 110 between multiple base stations (not shown) and enforcing particular quality of service (QoS) characteristics for each flow being served. In various implementations, such as those implementing the Proxy Mobile IP standard, SGW 132 may include a Bearer Binding and Event Reporting Function (BBERF). In various exemplary embodiments, EPC 130 may include multiple SGWs (not shown) and each SGW may communicate with multiple base stations (not shown).

Packet data network gateway (PGW) 134 may be a device that provides gateway access to packet data network 140. PGW 134 may be the final device within the EPC 130 that receives packets sent by user equipment 110 toward packet data network 140 via SGW 132. PGW 134 may include a policy and charging enforcement function (PCEF) that enforces policy and charging control (PCC) rules for each service data flow (SDF). Therefore, PGW 134 may be a policy and charging enforcement node (PCEN). PGW 134 may include a number of additional features such as, for example, packet filtering, deep packet inspection, and subscriber charging support. PGW 134 may also be responsible for requesting resource allocation for unknown application services.

Session control device 140 may be a device that provides various management or other functions within the EPC 130. For example, session control device 140 may provide a Policy and Charging Rules Function (PCRF). In various embodiments, session control device 140 may include an Alcatel Lucent 5780 Dynamic Services Controller (DSC). Session control device 140 may include a DRA 142, a plurality of policy and charging rules blades (PCRBs) 144, 146, and a subscriber profile repository.

DRA 142 may be an intelligent Diameter Routing Agent. As such, DRA 142 may receive, process, and transmit various Diameter messages. DRA 142 may include a number of user-defined rules that govern the behavior of DRA 142 with regard to the various Diameter messages DRA 142 may encounter. Based on such rules, the DRA 142 may operate as a relay agent, proxy agent, or redirect agent. For example, DRA 142 may relay received messages to an appropriate recipient device. Such routing may be performed with respect to incoming and outgoing messages, as well as messages that are internal to the session control device.

Policy and charging rules blades (PCRB) 144, 146 may each be a device or group of devices that receives requests for application services, generates PCC rules, and provides PCC rules to the PGW 134 or other PCENs (not shown). PCRBs 144, 146 may be in communication with AF 160 via an Rx interface. As described in further detail below with respect to AF 160, PCRB 144, 146 may receive an application request in the form of an Authentication and Authorization Request (AAR) from AF 160. Upon receipt of an AAR, PCRB 144, 146 may generate at least one new PCC rule for fulfilling the application request.

PCRB 144, 146 may also be in communication with SGW 132 and PGW 134 via a Gxx and a Gx interface, respectively. PCRB 144, 146 may receive an application request in the form of a credit control request (CCR) from SGW 132 or PGW 134. As with an AAR, upon receipt of a CCR, PCRB 144, 146 may generate at least one new PCC rule for fulfilling the application request. In various embodiments, the AAR and the CCR may represent two independent application requests to be processed separately, while in other embodiments, the AAR and the CCR may carry information regarding a single application request and PCRB 144, 146 may create at least one PCC rule based on the combination of the AAR and the CCR. In various embodiments, PCRB 144, 146 may be capable of handling both single-message and paired-message application requests.

Upon creating a new PCC rule or upon request by the PGW 134, PCRB 144, 146 may provide a PCC rule to PGW 134 via the Gx interface. In various embodiments, such as those implementing the proxy mobile IP (PMIP) standard for example, PCRB 144, 146 may also generate QoS rules. Upon creating a new QoS rule or upon request by the SGW 132, PCRB 144, 146 may provide a QoS rule to SGW 132 via the Gxx interface.

Subscriber profile repository (SPR) 148 may be a device that stores information related to subscribers to the subscriber network 100. Thus, SPR 148 may include a machine-readable storage medium such as read-only memory (ROM), random-access memory (RAM), magnetic disk storage media, optical storage media, flash-memory devices, and/or similar storage media. SPR 148 may be a component of one of PCRB 144, 146 or may constitute an independent node within EPC 130 or session control device 140. Data stored by SPR 148 may include subscriber information such as identifiers for each subscriber, bandwidth limits, charging parameters, and subscriber priority.

Packet data network 150 may be any network for providing data communications between user equipment 110 and other devices connected to packet data network 150, such as AF 160. Packet data network 150 may further provide, for example, phone or Internet service to various user devices in communication with packet data network 150.

Application function (AF) 160 may be a device that provides a known application service to user equipment 110. Thus, AF 160 may be a server or other device that provides, for example, a video streaming or voice communication service to user equipment 110. AF 160 may further be in communication with the PCRB 144, 146 of the EPC 130 via an Rx interface. When AF 160 is to begin providing known application service to user equipment 110, AF 160 may generate an application request message, such as an authentication and authorization request (AAR) according to the Diameter protocol, to notify the PCRB 144, 146 that resources should be allocated for the application service. This application request message may include information such as an identification of the subscriber using the application service, an IP address of the subscriber, an APN for an associated IP-CAN session, or an identification of the particular service data flows that must be established in order to provide the requested service.

As will be understood, various Diameter applications may be established within subscriber network 100 and supported by DRA 142. For example, an Rx application may be established between AF 160 and each of PCRBs 144, 146. As another example, an Sp application may be established between SPR 148 and each of PCRBs 144, 146. As yet another example, an S9 application may be established between one or more of PCRBs 144, 146 and a remote device implementing another PCRF (not shown). As will be understood, numerous other Diameter applications may be established within subscriber network 100.

In supporting the various potential Diameter applications, DRA 142 may receive Diameter messages, process the messages, and perform actions based on the processing. For example, DRA 142 may receive a Gx CCR from PGW 134, identify an appropriate PCRB 144, 146 to process the Gx CCR, and forward the Gx CCR to the identified PCRB 144, 146. DRA 142 may also act as a proxy by modifying the subsequent Gx CCA sent by the PCRB 144, 146 to carry an origin-host identification pointing to the DRA 142 instead of the PCRB 144, 146. Additionally or alternatively, DRA 142 may act as a redirect agent or otherwise respond directly to a request message by forming an appropriate answer message and transmitting the answer message to an appropriate requesting device.

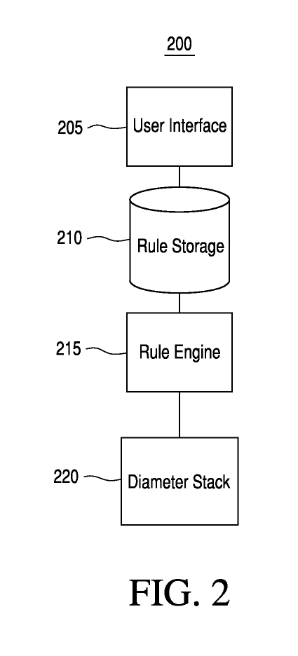

FIG. 2 illustrates an exemplary Diameter system 200. Diameter system 200 may include a number of components such as user interface 205, rule storage 210, rule engine 215, and Diameter stack 220.

Diameter system 200 may be a standalone device or a component of another system. For example, Diameter system 200 may correspond to DRA 142 of exemplary environment 100. In such an embodiment, DRA 142 may support various Diameter applications defined by the 3GPP such as Gx, Gxx, Rx, or Sp. Similarly, Diameter system 200 may correspond to PCRB 144 or 146 of exemplary environment 100. It will be understood that Diameter System 200 may be deployed in various alternative embodiments wherein additional or alternative applications are supported. As such, it will be apparent that the methods and systems described herein may be generally applicable to supporting any Diameter applications.

User interface 205 may include hardware or executable instructions on a machine-readable storage medium configured to enable communication with a user. As such, user interface 205 may include a network interface (such as a network interface included in Diameter stack 220), a monitor, a keyboard, a mouse, or a touch-sensitive display. User interface 205 may also provide a graphical user interface (GUI) for facilitating user interaction. User interface 205 may enable a user to customize the behavior of DRA 200. For example, user interface 205 may enable a user to define rules for storage in rule storage 210 and evaluation by rule engine 215. Various additional methods for a user to customize the behavior of DRA 200 via user interface 205 will be apparent to those of skill in the art.

Rule engine 215 may include hardware or executable instructions on a machine readable storage medium configured to process a received message by evaluating one or more rules stored in rule storage 210. As such, rule engine 215 may be a type of processing engine. Rule engine 215 may, for example, access one or more rule tables to process and execute specified actions based on the rules. Further, rule engine 215 may handle different scenarios in different ways.

Rule storage 210, may be any machine-readable medium capable of storing one or more rules for evaluation by rule engine 215. Accordingly, rule storage 210, may include a machine-readable storage medium such as read-only memory (ROM), random-access memory (RAM), magnetic disk storage media, optical storage media, flash-memory devices, and/or similar storage media. In various embodiments, rule storage 210 may store one or more rule sets as a binary decision tree data structure, a database, or a hash table. Various other data structures for storing a rule set will be apparent.

Diameter Stack 220 may include hardware or executable instructions on a machine-readable storage medium configured to exchange messages with other devices according to the Diameter protocol. Diameter stack 220 may include an interface including hardware or executable instructions encoded on a machine readable storage medium configured to communicate with other devices. For example, diameter stack 220 may include an Ethernet or TCP/IP interface. In various embodiments, diameter stack 220 may include multiple physical ports.

Diameter stack 220 may also be configured to read and construct messages according to the Diameter protocol. For example, Diameter stack may be configured to read and construct CCR, CCA, AAR, AAA, RAR, and RAA messages. Diameter stack 220 may provide an application programmer's interface (API) such that other components of Diameter system 200 may invoke functionality of Diameter stack. For example, rule engine 215 may be able to utilize the API to read an attribute-value pair (AVP) from a received CCR or to modify an AVP of a new CCA. Various additional functionalities will be apparent from the following description.

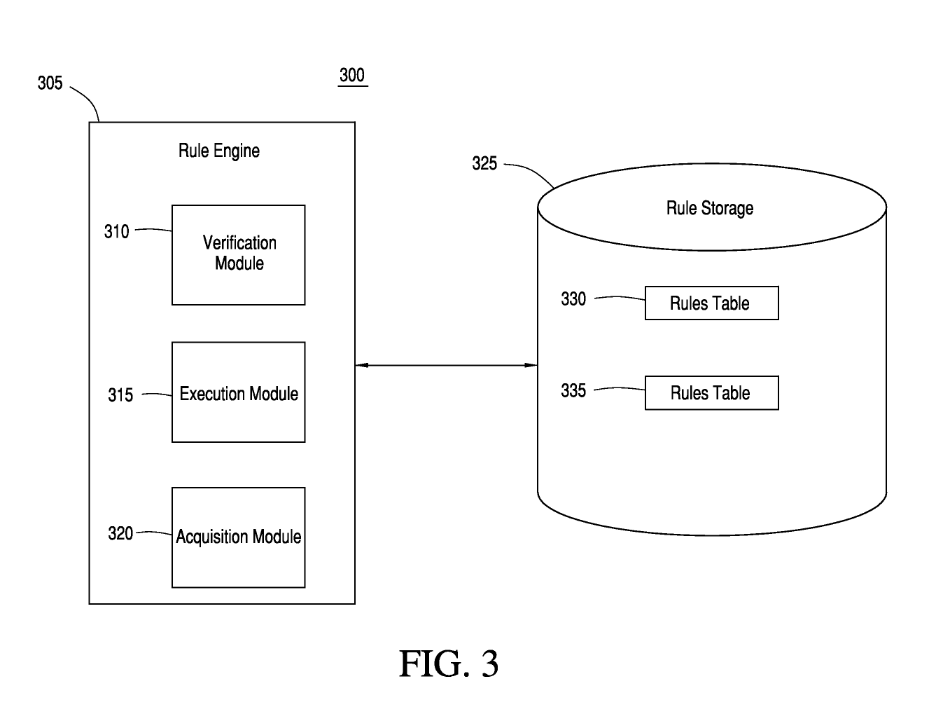

FIG. 3 illustrates an exemplary Diameter rules engine system 300. Diameter rules engine system 300 may be used, for example, by Diameter system 200 may correspond to 210, 215. Diameter rules engine system 300 may include a number of components such as rules engine 305, verification module 310, execution module 315, acquisition module 320, rules storage 325, and rules tables 330, 335.

Rules engine 305, may include hardware or executable instructions on a machine-readable storage medium configured to evaluate rules on a device such as PCRB 144 or DRA 142. Rules engine 305, may include hardware or executable instructions on a machine-readable storage medium configured to receive rules from other devices on the network, or to access rules already stored in rules storage 325. Rules engine 305 may include verification module 310, execution module 315 and acquisition module 320.

Acquisition module 320, may include hardware or executable instructions on a machine-readable storage medium configured to acquire rules to be processed and/or managed. Acquisition module 320 may include, for example, interfaces such as Gxx or Rx which enable receipt and transmission of application requests (AAR). The AAR's may be received and transmitted to or from, for example, application function 160. Acquisition module 320 may similarly access and communicate with rules storage 325 and rules tables 330, 335 where it may store and/or retrieve rules.

Rules may include, for example, policy and charging control (PCC) rules. Rules may indicate, for example, bandwidth requests, packet filters, subscriber identifiers and/or information, as well as data stream type. Rules may include partial, as well as full rule requests. Acquisition module 320 may send or receive rules to verification module 310.

Verification module 310, may include hardware or executable instructions on a machine-readable storage medium configured to verify whether or not one or more conditions of a rule are satisfied. Verification module 310 may receive a rule from acquisition module 320. Verification module may further send a verification result to execution module 315. The verification result may be, for example, that a rule's conditions as requested are satisfied. For example, a rule may indicate that for a certain subscriber type a Quality of Service (QoS) level is allowed. Therefore, verification module 310 may indicate what QoS is allowed. A verification decision from verification module 310 may include information such as values for charging parameters, QoS parameters, service identifiers, rating groups, online or offline charging method, metering method, reporting level, and/or allocation retention priority. Similarly, a rule may be a behavioral rule which is used to manage the Diameter system.

Verification module 310 may further create and/or access rules tables stored in rules storage 325. Verification module 310 may similarly use other data structures to store rules including a binary tree, a database, a table or a hash table. Verification module 310 may store all rules in one table. Similarly verification module 310 may sort rules according to different criteria and store them in two or more tables or data structures in rules storage 325.

Execution module 315, may include hardware or executable instructions on a machine-readable storage medium configured to execute certain actions as a result of a received rule's conditions, being satisfied or not. Actions may include changing the quality of service, charging a user for certain services, and beginning streaming services.

Rules storage 325, may be any machine-readable medium capable of storing one or more rules such as rule storage 210. Rules storage may include rules tables 330, 335 for evaluation by rules engine 305. Accordingly, rules storage 325, may include a machine-readable storage medium such as read-only memory (ROM), random-access memory (RAM), magnetic disk storage media, optical storage media, flash-memory devices, and/or similar storage media. Rule storage 325, may store definitions of behavioral rules, for example, Diameter routing configuration settings, global variables, system properties, methods related to Java or other routine objects. For example, settings may be stored including a router's local identity, the router realm, the router next realm and a maximum number of active sessions. A rule may include a condition as well as a list of actions as such:

class Rule {

Condition condition;
List<Action> actions;

}

Similarly a rule table may include an array or list of rules or like classes or objects as such:

class RuleTable {

List<Rule> rules;

}

Another data format for a rule may include a list of unconditional actions, conditions and a list or array of actions each associated with a conditional action such as:

class Rule {

List<Action> unconditionalActions;
Condition condition;

List<Action> actions;
}

Finally, a data structure may be used, such as a java class object, table or hash including several rules which may create a rule set such as:

class RuleTable {

List<Rule> rules;

}

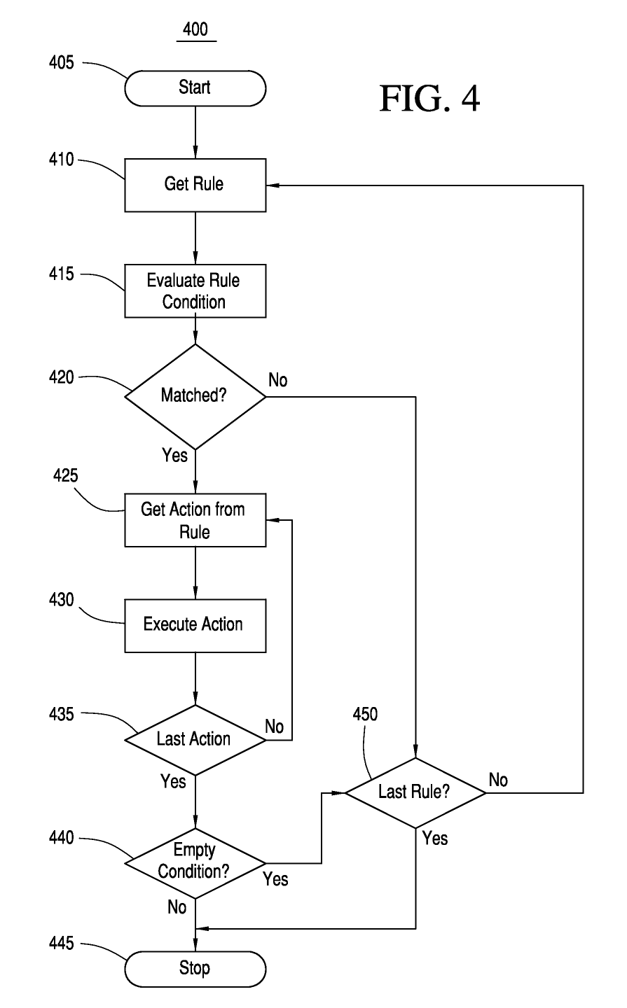

FIG. 4 illustrates an exemplary method for evaluating Diameter rules 400. In exemplary method for managing Diameter rules 400, in evaluating a rule with no condition or no criteria the method may continue execution of the rule table. Diameter System 200, for example, may begin in step 405 and proceed to step 410 where it may receive one or more diameter rules. The Diameter rules may be received via transmission or stored locally via settings and/or a UI. Similarly, getting the Diameter rules may be accomplished by retrieving rules from rules storage 325 and/or one of rules tables 330, or 335.

Diameter system 200 may then proceed to step 415, where it may evaluate a rule's condition. For example, a rule may be a behavioral rule which includes conditions and actions to manage the Diameter messaging system.

Diameter system 200 may then proceed to step 420, where it may decide how to proceed whether or not the condition has been matched. If the condition has not been matched Diameter system 200 may proceed to step 450 to determine if the rule is the last rule in a list.

If the condition has been matched, Diameter system 200 may then proceed to step 425, where it may retrieve an action to be accomplished as specified by the rule.

Diameter system 200 may then proceed to step 430, where it may execute one of a number of actions as specified by the one or more rules. For example, there may be a plurality of actions to be performed for one rule. Similarly, there may be one action to be performed for one rule. For example, Diameter system 200 may call one or more methods of an established Java or other routine object as specified by the action portion of the rule.

Diameter system 200 may then proceed to step 435, where it may determine if the last action has been executed. When the last action has not been executed Diameter system 200 may proceed to step 425.

If the last action has been executed, Diameter system 200 may then proceed to step 440, where it may retrieve another rule condition and determine if a retrieved rule condition is an empty condition.

Diameter system 200 may proceed to step 450 when the rule condition is empty. Diameter system 200 may similarly proceed to step 445 when the rule condition is non-empty.

In step 450, Diameter system 200 may determine if the last rule in the rules list has been retrieved and processed. Diameter system 200 may proceed to step 445 where it may stop operation, when the rule is the last rule. When the rule is not the last rule, Diameter system 200 may proceed to step 410.

An exemplary algorithmic pseudo code for evaluating a rule table according to FIG. 4 is as follows:

for (Rule currentRule : RuleTable.getRules( ))
{

boolean matched = evaluate(currentRule.getCondition( ));
if (matched == true)

for (Action action : currentRule.getActions( ))
{

execute(action);

}
if (!isEmptyCondition(currentRule.getCondition( ))
{

break; // A non-empty condition was met. Stop processing
the rule table.

}

}

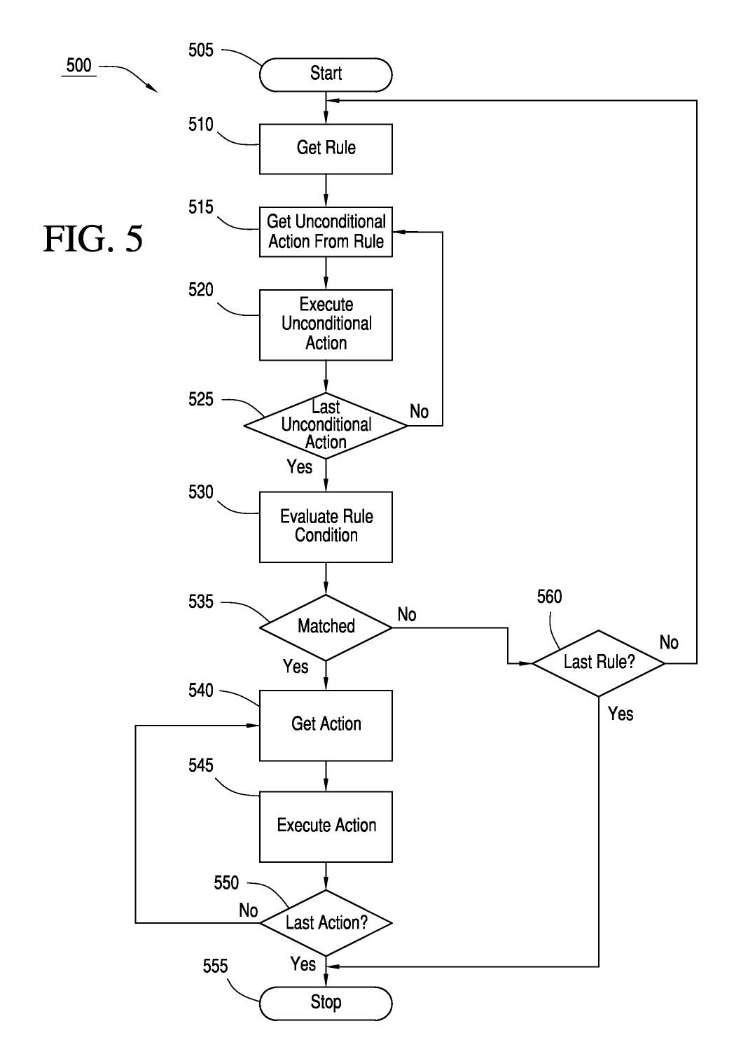

FIG. 5 illustrates an exemplary alternative method for evaluating Diameter rules 500 including unconditional statements. Diameter system 200, for example, may begin in step 505 and proceed to step 510 where it may receive one or more diameter rules. The Diameter rules may be retrieved from rules storage 325 and/or one of rules tables 330, or 335.

Diameter system 200 may then proceed to step 515, where Diameter system 200 may retrieve one or more actions which are unconditional. In some cases no unconditional actions may be present. Diameter system 200 may proceed to step 530.

Diameter system 200 may then proceed to step 520, where Diameter system 200 may execute the one or more retrieved unconditional actions associated with the relevant rules. For example, system properties may be changed in some embodiments. In one embodiment, a local identity, next-realm or other global variables may be set.

Diameter system 200 may then proceed to step 525, where Diameter system 200 may determine if the current unconditional action is the last unconditional action in the list. When the current unconditional action is not the last unconditional action then Diameter system 200 may return to step 515.

When the current unconditional action is the last unconditional action then Diameter system 200 may proceed to step 530. In step 530, Diameter system 200 may retrieve as well as evaluate a condition associated with the current rule.

Diameter system 200 may then proceed to step 535, where Diameter system 200 may determine if the condition which was retrieved matches the rule condition. For example, if a system property is set to true, or certain key values are set as the condition requires the condition(s) may be met. When the conditions are not met, Diameter system 200 may proceed to step 560 where it may determine if the rule is the last rule. If the rule is the last rule, Diameter system 200 may proceed to step 555. If the rule is not the last rule, Diameter system 200 may proceed to step 510

If the conditions are not met 535, Diameter system 200 may then proceed to step 540, where Diameter system 200 may retrieve an action associated with the current condition when the condition(s) is/are met.

Diameter system 200 may then proceed to step 545, where Diameter system 200 may execute the action which was retrieved in step 540. Actions executed may include any kind of action such as setting local properties, system properties or global variables.

Diameter system 200 may then proceed to step 550, where Diameter system 200 may determine if there are any further actions to be executed related to the current condition and rule.

When the action is the last to be executed, Diameter system 200 may then proceed to step 555. In step 555 Diameter system 200 may stop operation. When the action is not the last action, Diameter system 200 may proceed to step 540 to retrieve another action.

An exemplary algorithm pseudo code for evaluating a rule table is as follows:

for (Rule currentRule : RuleTable.getRules( ))
{

for (Action unconditionalAction :
currentRule.getUnconditionalActions( ))
{

execute(unconditionalAction);

}

boolean matched = evaluate(currentRule.getCondition( ));
if (matched == true)

for (Action action : currentRule.getActions( ))

{

{

execute(action);

}

break; // A condition was met. Stop processing the rule
table.

}
}

Another exemplary embodiment may include utilizing two parallel sets of rules for each rule table. The first set of rules may have no conditions. Similarly, the first set of rules may have actions. The second set of rules may include a condition followed by actions.

In yet another embodiment, there may be two parallel sets of rules for each rule table. One rule set may have no criteria for the rules. When evaluating rules, the actions of the criteria-less rule, may run. The rule of the second set may then be evaluated. The actions may be run when they match.

When evaluating rules, the rule from the rule table without conditions may be evaluated, resulting in the actions of that rule being evaluated. Next, the condition of the rule of the second set may be evaluated. When the condition is true, then the actions of that rule may be executed and further processing of the rule table may cease.

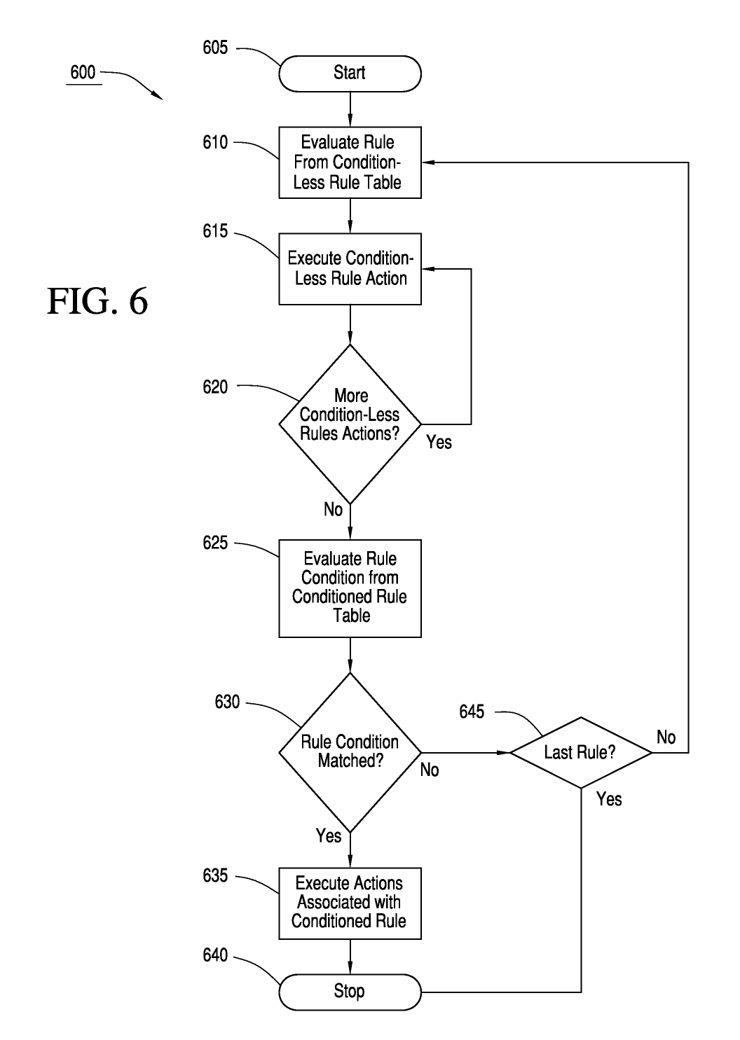

FIG. 6 illustrates an exemplary alternative method for evaluating Diameter rules 600 including two sets of rules for each rules tables. Diameter system 200, for example, may begin in step 605 and proceed to step 610 where it may evaluate a rule from the unconditional rule set of a rules table. The Diameter rules may be retrieved from rules storage 325 and/or one of rules tables 330, or 335.

Diameter system 200 may then proceed to step 615, where Diameter system 200 may execute one of the actions associated with the condition-less rule.

Diameter system 200 may then proceed to step 620, where Diameter system 200 may check if there are more actions associated with the condition-less rule. When there are more actions associated with the condition-less rule Diameter system 200 may proceed to step 615 to execute the next action.

Diameter system 200 may then proceed to step 625, where Diameter system 200 may evaluate the rule's condition which is associated with the rule in the section of the rules table where the rules have conditions.

Diameter system 200 may then proceed to step 630, where Diameter system 200 may determine if the rules condition has matched. When the rule's condition has matched, Diameter system 200 may proceed to step 635. When the rule's condition has not been matched, Diameter system 200 may proceed to step 645 where it may determine if there are more rules. When the rule is last rule, Diameter system 200 may proceed to step 640 where it may stop. Otherwise, Diameter system 200 may proceed to step 610 where it may retrieve another rule.

When the rule's condition has been matched, Diameter system 200 may then proceed to step 635, where Diameter system 200 may execute all actions associated with the conditioned rule. Diameter system 200 may then proceed to step 640, where Diameter system 200 may stop operation.

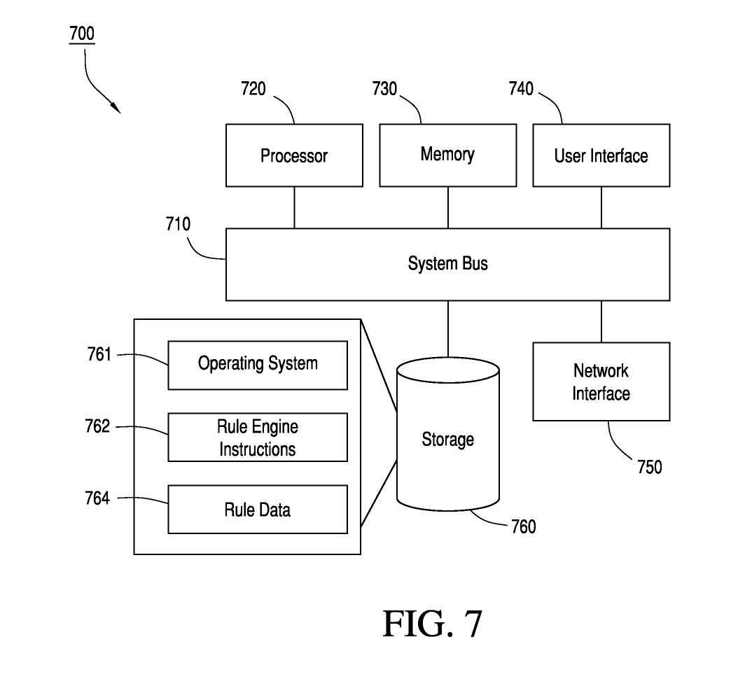

FIG. 7 illustrates an exemplary hardware diagram for a device 700 such as device including an agent in a system. The exemplary device 700 may correspond to Diameter system 200 of FIG. 2. As shown, the device 700 includes a processor 720, memory 730, user interface 740, network interface 750, and storage 760 interconnected via one or more system buses 710. It will be understood that FIG. 7 constitutes, in some respects, an abstraction and that the actual organization of the components of the device 700 may be more complex than illustrated.

The processor 720 may be any hardware device capable of executing instructions stored in memory 730 or storage 760. As such, the processor may include a microprocessor, field programmable gate array (FPGA), application-specific integrated circuit (ASIC), or other similar devices.

The memory 730 may include various memories such as, for example L1, L2, or L3 cache or system memory. As such, the memory 730 may include static random access memory (SRAM), dynamic RAM (DRAM), flash memory, read only memory (ROM), or other similar memory devices.

The user interface 740 may include one or more devices for enabling communication with a user such as an administrator. For example, the user interface 740 may include a display, a mouse, and a keyboard for receiving user commands.

The network interface 750 may include one or more devices for enabling communication with other hardware devices. For example, the network interface 750 may include a network interface card (NIC) configured to communicate according to the Ethernet protocol. Additionally, the network interface 750 may implement a TCP/IP stack for communication according to the TCP/IP protocols. Various alternative or additional hardware or configurations for the network interface 750 will be apparent.

The storage 760 may include one or more machine-readable storage media such as read-only memory (ROM), random-access memory (RAM), magnetic disk storage media, optical storage media, flash-memory devices, or similar storage media. In various embodiments, the storage 760 may store instructions for execution by the processor 720 or data upon with the processor 720 may operate. For example, the storage 760 may store operating system 761 to process the rules engines' instructions. The storage 760 may store rule engine instructions 762 for performing rules management according to the concepts described herein. The storage may also store Rule Data 764 for use by the processor executing the rule engine instructions 762.

It should be apparent from the foregoing description that various exemplary embodiments of the invention may be implemented in hardware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a machine-readable storage medium may include read-only memory (ROM), random-access memory (RAM), magnetic disk storage media, optical storage media, flash-memory devices, and similar storage media.

While the host device 700 is shown as including one of each described component, the various components may be duplicated in various embodiments. For example, the processor 720 may include multiple microprocessors that are configured to independently execute the methods described herein or are configured to perform steps or subroutines of the methods described herein such that the multiple processors cooperate to achieve the functionality described herein. Further, where the device 700 is implemented in a cloud computing system, the various hardware components may belong to separate physical systems. For example, the processor 720 may include a first processor in a first server and a second processor in a second server.

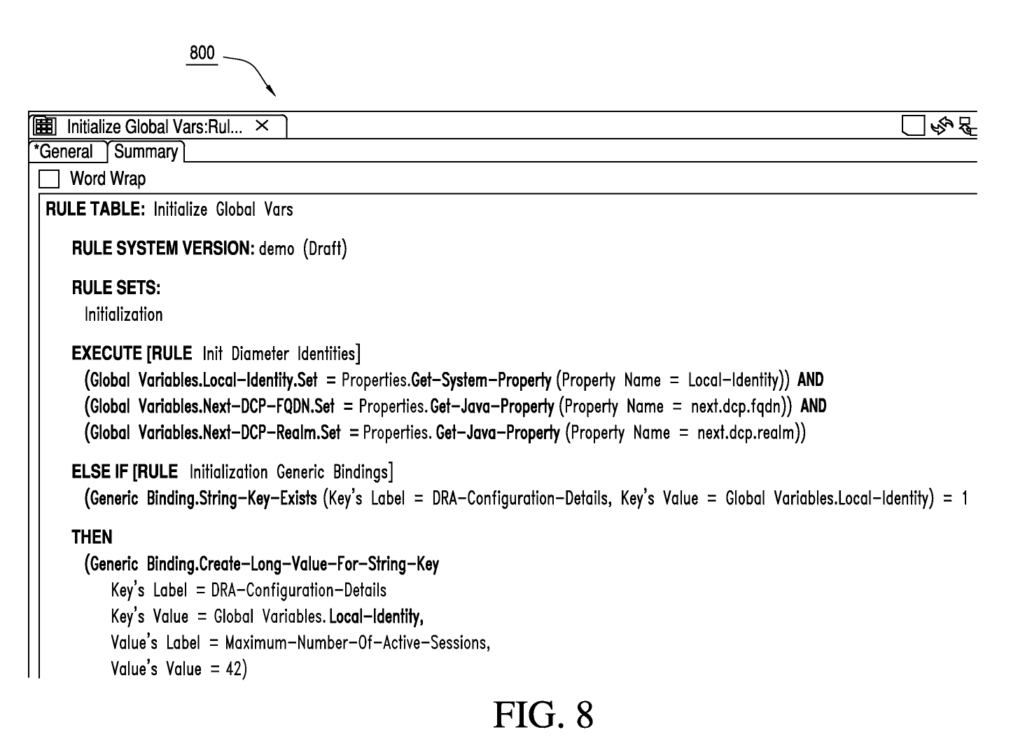

FIG. 8 illustrates an exemplary unconditional rule 800. Exemplary unconditional rule 800 has a condition-less rule whose actions are always executed, and a conditional rule whose action may or may not be executed. The execute statement executes all three actions listed without performing any checking. The else if statement next may check the condition of whether initialization generic bindings is true. When initialization generic bindings is true, DRA 142 may perform certain actions such setting key label, key value, value label and value's value.

It should be appreciated by those skilled in the art that any block diagrams herein represent conceptual views of illustrative circuitry embodying the principals of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

What is claimed is:

1. A method performed by a Diameter device for managing a Diameter rules table, the method comprising:
retrieving a first Diameter rule from the Diameter rules table;
determining a set of criteria associated with the first Diameter rule;
executing an action associated with the first Diameter rule and ending evaluation of a rules set when the set of criteria is non-empty and is met; and
executing an action associated with the first Diameter rule and retrieving a second Diameter rule from the Diameter rules table for evaluation when the set of criteria is empty.

2. The method of claim 1, further comprising:
retrieving a second diameter rule from the Diameter rules table when the set of criteria is non-empty and the set of criteria is not met.

3. The method of claim 1, wherein the Diameter rules table contains multiple sets of empty criteria.

4. The method of claim 3, wherein the Diameter device retrieves a different Diameter rule subsequent to evaluation of each empty criteria.

5. The method of claim 1, wherein determining a set of criteria further comprises:
determining that one criterion in the set is empty; and
continuing evaluation of the rule set when the criterion is determined to be empty.

6. The method of claim 1, further comprising:
executing multiple actions associated with the first Diameter rule when the set of criteria is non-empty.

7. A non-transitory machine-readable storage medium encoded with instructions for execution by a Diameter device for managing a Diameter rules table, the medium comprising:
instructions for retrieving a first Diameter rule from the Diameter rules table;
instructions for determining a set of criteria associated with the first Diameter rule;
instructions for executing an action associated with the first Diameter rule and ending evaluation of a rules set when the set of criteria is non-empty and is met; and
instructions for executing an action associated with the first Diameter rule and retrieving a second Diameter rule from the Diameter rules table for evaluation when the set of criteria is empty.

8. The non-transitory machine-readable storage medium of claim 7, further comprising:
instructions for retrieving a second diameter rule from the Diameter rules table when the set of criteria is non-empty and the set of criteria is not met.

9. The non-transitory machine-readable storage medium of claim 7, wherein the Diameter rules table contains multiple sets of empty criteria.

10. The non-transitory machine-readable storage medium of claim 9, wherein the Diameter device retrieves a different Diameter rule subsequent to evaluation of each empty criteria.

11. The non-transitory machine-readable storage medium of claim 7, wherein determining a set of criteria further comprises:
determining that one criterion in the set is empty; and
continuing evaluation of the rule set when the criterion is determined to be empty.

12. The non-transitory machine-readable storage medium of claim 7, further comprising:
executing multiple actions associated with the first Diameter rule when the set of criteria is non-empty.

13. A Diameter rules agent (DRA) for managing a Diameter rules queue, the DRA comprising:
a rule storage configured to store a Diameter rules table;
a processor configured to:
retrieve a first Diameter rule to be placed in the Diameter rules table;
evaluate the first Diameter rule to determine a set of criteria associated with the first Diameter rule;
execute an action associated with the first Diameter rule and ending evaluation of a rules set when the set of criteria is non-empty and is met; and
execute an action associated with the first Diameter rule and retrieve a second Diameter
rule from the Diameter rules table for evaluation when the set of criteria is empty.

14. The DRA of claim 13, wherein the DRA is further configured to:
retrieve a second diameter rule from the Diameter rules table when the set of criteria is non-empty and the set of criteria is not met.

15. The DRA of claim 14 wherein the DRA is further configured to:
retrieve a different Diameter rule subsequent to evaluation of each empty criteria.

16. The DRA of claim 13, wherein to determine a set of criteria, the DRA is further configured to:
determine one criterion in the set which is empty; and
the DRA continues to evaluate the rule set when the criterion is determined to be empty.

17. The DRA of claim 13, wherein the DRA is further configured to:
execute multiple actions associated with the first Diameter rule when the set of criteria is non-empty.

18. The DRA of claim 13, wherein to receive a first Diameter rule the DRA is further configured to:
receive a list of rules from a user using a user interface, the list including conditional and unconditional rules.
